(19) United States
(12) Patent Application Publication
(10) Pub. No.: US 2010/0185489 A1
(43) Pub. Date: Jul. 22, 2010

(54) METHOD FOR DETERMINING A PERSONALIZED TRUE COST OF SERVICE OFFERINGS

(76) Inventors: Ramakrishna V. Satyavolu, Fremont, CA (US); Saravana Perumal, Fremont, CA (US); Samir Kothari, Menlo Park, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/501,572

(22) Filed: Jul. 13, 2009

Related U.S. Application Data
(60) Provisional application No. 61/146,120, filed on Jan. 21, 2009.

(51) Int. Cl. G06Q 30/00; G06Q 10/00; G06Q 50/00; G06N 5/02; G06Q 40/00

(52) U.S. Cl. 705/10; 705/14.25; 706/47

(57) ABSTRACT

In embodiments of the invention, comparing service plans based on a user's usage data may include collecting at least one of predicted and past service usage and reward earnings data for a user's current service using a computer implemented facility, analyzing the service usage and rewards earnings data to obtain a normalized service usage and rewards dataset, normalizing data related to a plurality of alternative service offerings according to a normalized alternative service offering model, applying the normalized alternative service offering model to the normalized service usage and rewards dataset to produce a plurality of alternative service offering normalized datasets and comparing the alternative service offering normalized datasets to the normalized usage dataset according to at least one element of the datasets to determine if an alternative service offering is better than the user's current service. Related user interfaces, applications, and computer program products are disclosed.

### CROSS REFERENCE TO RELATED APPLICATIONS

This application claims the benefit of the following provisional application, which is hereby incorporated by reference in its entirety: U.S. Patent Application Ser. No. 61/146,120, filed Jan. 21, 2009, the entire disclosure of which is herein incorporated by reference.

### BACKGROUND

1. Field

The present invention is generally related to consumer comparison shopping and usage based service analysis.

2. Description of the Related Art

While consumer comparison shopping for products is knows, an unbiased way of comparison shopping for competing services is unavailable. Often a consumer may only be aware of some of the information related to a service provider's services, options, terms, conditions, costs, and the like. Also, the consumer may not be aware of how the service options change based on their particular usage characteristics. Thus, there remains a need for a consumer comparison shopping method that obtains actual or predicted service usage data from the consumer and service provider information in order to present the consumer with relevant alternative service offering options.

### SUMMARY

In an aspect of the invention, a machine readable medium may include program instructions stored thereon for comparing service plans based on a user's usage data executable by a processing unit. The program instructions may include the steps of collecting at least one of predicted and past service usage and reward earnings data for a user's current service using a computer implemented facility, analyzing the service usage and rewards earnings data to obtain a normalized service usage and rewards dataset, normalizing data related to a plurality of alternative service offerings according to a normalized alternative service offering model, applying the normalized alternative service offering model to the normalized service usage and rewards dataset to produce a plurality of alternative service offering normalized datasets, and comparing the alternative service offering normalized datasets to the normalized usage dataset according to at least one element of the datasets to determine if an alternative service offering is better than the user's current service. The program instructions may further include repeating said collecting, analyzing, normalizing, applying and comparing periodically to determine on an updated basis which alternative service offering is better than the user's current service. The program instructions may further include alerting the user when an alternative service offering that is better than the user's current service is available. The program instructions may further include calculating an aggregate score for each of the plurality of alternative service offering normalized datasets. The aggregate score may include cost and at least one other element. The other element may be selected from the group consisting of total cost, per unit cost, savings, and service quality. The user may specify which aspects of the alternative service offering normalized dataset to include in the aggregate score. The program instructions may further include ranking the plurality of alternative service offering normalized datasets based on the aggregate score. The program instructions may further include collecting terms and conditions for the user's current service, analyzing the terms and conditions, calculating an aggregate score for the terms and conditions, and adding the aggregate score to the aggregate score for the normalized usage dataset. The program instructions may further include collecting terms and conditions for the alternative service offerings, analyzing the terms and conditions, calculating an aggregate score for the terms and conditions, and adding the aggregate score to the aggregate score for the alternative service offering normalized dataset. The data related to a plurality of alternative service offerings are obtained from a human-assisted normalization system. The data related to a plurality of alternative service offerings are obtained from public information sources. The data related to a plurality of alternative service offerings may be obtained through direct connections to service providers. The service usage data may be input manually by the user to the computer implemented facility. Normalizing data related to the plurality of alternative service offerings may include defining a plurality of service usage-related data types, collecting parameters related to a service usage using the computer implemented facility, and normalizing the service parameters according to the defined service usage-related data types to generate a normalized alternative service offering model. The service offering may be a wireless service offering, the service usage data and data related to the alternative service offering relate to at least one wireless service related item. The service offering may be a credit card offering, the service usage data and data related to the alternative service offering relate to at least one credit card related item. Comparing may include ranking the alternative service offerings according to an aggregate score calculated for the alternative service offering normalized dataset. Comparing may include ranking the alternative service offerings according to cost and an aspect of the alternative service offering normalized dataset. Comparing may include ranking the alternative service offerings according to total costs, per unit costs, and/or service quality.

In an aspect of the invention, a machine readable medium may include program instructions stored thereon for comparing service plans based on a user's usage data executable by a processing unit. The program instructions may include the steps of collecting at least one of predicted and past service usage and reward earnings data for a user's current service using a computer implemented facility, analyzing the service usage and rewards earnings data to obtain a normalized service usage and rewards dataset, normalizing data related to a plurality of alternative service offerings according to a normalized alternative service offering model, applying the normalized alternative service offering model to the normalized service usage and rewards dataset to produce a plurality of alternative service offering normalized datasets, comparing the alternative service offering normalized datasets to the normalized usage dataset according to at least one element of the datasets to determine if an alternative service offering is better than the user's current service, repeating said collecting, analyzing, normalizing, applying and comparing periodically to determine on an updated basis which alternative service offering is better than the user's current service, and alerting the user when an alternative service offering that is better than the user's current service is available. The program instructions may further include calculating an aggregate score for each of the plurality of alternative service offering normalized datasets. The aggregate score may include cost and at least one other element. The other element may be selected from the group consisting of total cost, per unit cost, savings, and service quality. 5. The medium of claim 2, wherein the user specifies which aspects of the alternative service offering normalized dataset to include in the aggregate score. The program instructions may further include ranking the plurality of alternative service offering normalized datasets based on the aggregate score. The program instructions may further include collecting terms and conditions for the user's current service, analyzing the terms and conditions, calculating an aggregate score for the terms and conditions, and adding the aggregate score to the aggregate score for the normalized usage dataset. The program instructions may further include collecting terms and conditions for the alternative service offerings, analyzing the terms and conditions, calculating an aggregate score for the terms and conditions, and adding the aggregate score to the aggregate score for the alternative service offering normalized dataset. The data related to a plurality of alternative service offerings may be obtained from a human-assisted normalization system. The data related to a plurality of alternative service offerings may be obtained from public information sources. The data related to a plurality of alternative service offerings may be obtained through direct connections to service providers. The service usage data may be input manually by the user to the computer implemented facility. The service usage data may relate to a predicted future usage. The service usage data may consist of average usage data over a specified period of time in the past. Normalizing data related to the plurality of alternative service offerings may include defining a plurality of service usage-related data types, collecting parameters related to a service usage using the computer implemented facility, and normalizing the service parameters according to the defined service usage-related data types to generate a normalized alternative service offering model. When the service offering is a wireless service offering, the service usage data and data related to the alternative service offering may relate to at least one wireless service related item. When the service offering is a credit card offering, the service usage data and data related to the alternative service offering may relate to at least one credit card related item. Comparing may include ranking the alternative service offerings according to an aggregate score calculated for the alternative service offering normalized dataset. Comparing may include ranking the alternative service offerings according to cost and an aspect of the alternative service offering normalized dataset. Comparing may include ranking the alternative service offerings according to total costs, per unit costs, and/or service quality.

In an aspect of the invention, a system for estimating the cost of an alternative service may include a decision engine that applies a normalized alternative service offering model to a normalized service usage dataset to produce a plurality of alternative service offering normalized datasets, and a ranking facility that compares the alternative service offering normalized datasets to the normalized usage dataset to determine if an alternative service offering is better than the user's current service. The ranking facility may optionally consider weights of certain dataset factors in comparing datasets. The ranking facility may compare datasets based on cost. The cost may be the cost of the service offering. The cost may be a monthly savings over an existing service. The cost may be an annual savings over an existing service. The ranking facility may compare datasets based on cost plus another factor. The factors may be weighted by a user. The factors may be assigned a score. The score may be based on relevance to personal usage. The ranking facility may compare datasets based on a calculated score. The score may be based on relevance to personal usage. The ranking facility may compare datasets based on rewards associated with a credit card offering. The system may further include a monitoring engine that causes the system to periodically compare service offerings to determine on an updated basis which alternative service offering is better than the user's current service. The monitoring engine may alert the user when an alternative service offering that is better than the user's current service is available. The system may further include a data engine that collects service parameters related to a service usage using a computer implemented facility. The system may further include a business rules server that stores definitions of a plurality of service usage-related data types. The system may further include a data normalization engine that normalizes the service parameters according to the defined service usage-related data types to generate a normalized service usage model for alternative service offerings and a normalized service usage dataset for a user's current service. The normalized service usage model may be stored in a product database. The normalized service usage dataset may be stored in a user profile database. The results from comparing may be stored in a tracking database.

In an aspect of the invention, a system for comparing service offerings may include a business rules server for storing definitions of a plurality of service usage-related data types, a data engine for collecting service parameters related to a service usage using a computer implemented facility, a data normalization engine for normalizing the service parameters according to the defined service usage-related data types to generate a normalized service usage model for alternative service offerings and a normalized service usage dataset for a user's current service, a decision engine for applying the normalized service usage model to the normalized service usage dataset to produce a plurality of alternative service offering normalized datasets, and a ranking facility for comparing the alternative service offering normalized datasets to the normalized usage dataset to determine if an alternative service offering is better than the user's current service. The system may further include a monitoring engine for causing the system to periodically compare service offerings to determine on an updated basis which alternative service offering is better than the user's current service. The normalized service usage model may be stored in a product database. The normalized service usage dataset may be stored in a user profile database. The results from comparing may be stored in a tracking database.

In an aspect of the invention, a machine readable medium may have program instructions stored thereon for generating a normalized service usage model executable by a processing unit. The program instructions may include the steps of defining a plurality of service usage-related data types, collecting service parameters related to a service usage using a computer implemented facility, and normalizing the service parameters according to the defined service usage-related data types to generate a normalized service usage model. The program instructions may further include repeating said collecting and normalizing periodically to determine the normalized service usage model on an updated basis. The parameters related to a service usage may be obtained from public information sources. The public information source may be a data feed file. The public information source may be a web crawl. The parameters related to a service usage may be obtained through direct connections to utility service providers. The parameters may be supplied or extracted. The parameters related to a service usage may be input manually by the user to the computer implemented facility. The program instructions may further include prioritizing the service usage-related data types prior to normalizing. The service parameter may be a user review. The service parameter may be an adoption rate.

In an aspect of the invention, a machine readable medium may have program instructions stored thereon for normalizing service usage data executable by a processing unit. The program instructions may include the steps of defining a plurality of service usage-related data types, collecting service usage data using a computer implemented facility, and sorting the service usage data according to the defined service plan-related data types. The program instructions may further include repeating said collecting and sorting periodically to normalize service usage data on an updated basis. The service usage data may be input manually by the user to the computer implemented facility. The service usage data may be a predicted future usage. The service usage data may be obtained for multiple services. The service usage data may be automatically collected by the computer implemented facility. The service usage data may include billing records. The billing records may be for a current bill only, historical billing, or a paper bill. The computer implemented facility may utilize a secure retrieval application. The service usage data may be obtained for multiple utility services. The service usage data may be historical service usage data or for a single time period.

In an aspect of the invention, a machine readable medium may have program instructions stored thereon for comparing wireless service plans based on a user's usage data executable by a processing unit. The program instructions may include the steps of collecting wireless service usage data for a user's current wireless service using a computer implemented facility, analyzing the wireless service usage data to obtain a normalized wireless service usage dataset, normalizing data related to a plurality of alternative wireless service offerings according to a normalized alternative wireless service offering model, applying the normalized alternative wireless service offering model to the normalized wireless usage dataset to produce a plurality of alternative wireless service offering normalized datasets, and comparing the alternative wireless service offering normalized datasets to the normalized wireless service usage dataset to determine if an alternative wireless service offering is better than the user's current wireless service.

In an aspect of the invention, a machine readable medium may have program instructions stored thereon for comparing savings accounts based on a user's usage data executable by a processing unit. The program instructions may include collecting savings account usage data for a user's current savings account using a computer implemented facility, analyzing the savings account usage data to obtain a normalized savings account usage dataset, normalizing data related to a plurality of alternative savings account offerings according to a normalized alternative savings account offering model, applying the normalized alternative savings account offering model to the normalized savings account usage dataset to produce a plurality of alternative savings account offering normalized datasets, and comparing the alternative savings account offering normalized datasets to the normalized savings account usage dataset to determine if an alternative savings account offering is better than the user's current savings account.

In an aspect of the invention, a machine readable medium may have program instructions stored thereon for comparing combined internet, television, and telephone services based on a user's usage data executable by a processing unit. The program instructions may include collecting combined internet, television, and telephone service usage data for a user's current combined internet, television, and telephone service using a computer implemented facility, analyzing the combined internet, television, and telephone service usage data to obtain a normalized combined internet, television, and telephone service usage dataset, normalizing data related to a plurality of alternative combined internet, television, and telephone service offerings according to a normalized alternative combined internet, television, and telephone service offering model, applying the normalized alternative combined internet, television, and telephone service offering model to the normalized combined internet, television, and telephone usage dataset to produce a plurality of alternative combined internet, television, and telephone service offering normalized datasets, and comparing the alternative combined internet, television, and telephone service offering normalized datasets to the normalized combined internet, television, and telephone service usage dataset to determine if an alternative combined internet, television, and telephone service offering is better than the user's current combined internet, television, and telephone service.

In an aspect of the invention, a machine readable medium may have program instructions stored thereon for comparing credit cards based on a user's usage data executable by a processing unit. The program instructions may include performing a preliminary classification of a user's credit card usage data to associate the user with a group of known characteristics, collecting credit card usage data for a user's current credit card using a computer implemented facility according to the preliminary classification, analyzing the credit card usage data to obtain a normalized credit card usage dataset, normalizing data related to a plurality of alternative credit cards according to a normalized credit card model, applying the normalized credit card model to the normalized credit card usage dataset to produce a plurality of alternative credit card normalized datasets, and comparing the alternative credit card datasets to the normalized credit card usage dataset to determine if an alternative credit card is better than the user's current credit card. The preliminary classification may include determining if the user pays their credit card balance off every month. If the user pays off their balance every month, the credit card usage data collected may be at least one of monthly spending, credit rating, categories of spending, current credit card, and number of years holding current credit card. If the user does not pay off their balance every month, the credit card usage data collected may be at least one of monthly spending, credit rating, categories of spending, current credit card, number of years holding current credit card, existing balance, interest rate, late payments, and monthly payment. The program instructions may further include calculating an aggregate score for each of the plurality of alternative credit card normalized datasets. The aggregate score comprises cost and at least one other element. The other element may be selected from the group consisting of total cost, per unit cost, savings, and rewards value. The user may specify which aspects of the alternative credit card normalized datasets to include in the aggregate score. The program instructions may further include ranking the plurality of alternative credit card normalized datasets based on the aggregate score. The program instructions may further include collecting terms and conditions for the user's current credit card, analyzing the terms and conditions, calculating an aggregate score for the terms and conditions, and adding the aggregate score to the aggregate score for the normalized usage dataset. The program instructions may further include collecting terms and conditions for the alternative credit cards, analyzing the terms and conditions, calculating an aggregate score for the terms and conditions, and adding the aggregate score to the aggregate score for the alternative credit card normalized dataset. The data related to the plurality of alternative credit cards may be obtained from public information sources. The data related to the plurality of alternative credit cards may be obtained through direct connections to credit card providers. The credit card data may be input manually by the user to the computer implemented facility. The credit card data may relate to a predicted future usage. The credit card data may be obtained for multiple credit cards. The credit card data may include average usage data over a specified period of time in the past. The credit card data may be automatically collected by the computer implemented facility. The credit card data may include billing records. The billing records may be for a current bill only, historical billing data, a paper bill, and an electronic bill. The computer implemented facility may utilize a secure retrieval application. The credit card data may be obtained for multiple credit cards. Analyzing may include processing historical usage data to obtain an average normalized usage dataset. Analyzing may include processing a single time period's usage data to obtain a normalized usage dataset for that time period. The program instructions may further include repeating said collecting, analyzing, normalizing, applying and comparing periodically to determine on an updated basis which alternative credit card is better than the user's current credit card. The program instructions may further include alerting the user when an alternative credit card that is better than the user's current credit card is available. Normalizing data related to the plurality of alternative credit cards may include defining a plurality of credit card usage-related data types, collecting parameters related to a credit card usage using the computer implemented facility, and normalizing the credit card parameters according to the defined credit card usage-related data types to generate a normalized alternative credit card model. Comparing may include ranking the alternative credit cards according to an aspect of the alternative credit card normalized dataset. The aspect may be the total card cost, a value of rewards, an additional earnings over the user's current credit card, savings over the user's current credit card, an introductory purchase APR, an introductory rate period, a purchase APR, an annual fee, a balance transfer fee, a credit level required, a reward type, a rewards sign-up bonus, a base earning rate, a maximum earning rate, or an earning limit. Comparing may include ranking the alternative credit cards according to an aggregate score calculated for the alternative credit card normalized dataset. The program instructions may further include plotting the aggregate score versus the cost for the alternative credit card. The user may be a business entity. The credit card usage data and data related to the alternative credit card may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, and features and benefits. The redemption may relate to at least one of domestic airfare, international airfare, car rentals, cash, charitable donations, consumer electronics, cruises, hotel stays, restaurants, shopping, an item of value, a service, or a class of services. The class of services may be one of first class, business class, coach class, and premium class. The rewards type may be at least one of cash, points, certificates, vouchers, discounts, and miles. The features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, and travel insurance. The program instructions may further include enabling the user to apply for a selected credit card. The program instructions may further include enabling the user to contact a current credit card provider in order to modify their current credit card terms and conditions. The program instructions may further include presenting an advertisement to the user, wherein the advertisement is selected based on an alternative credit card.

In an aspect of the invention, a data normalization platform for generating a normalized service usage model may include a business rules server for storing the definitions of a plurality of service usage-related data types, a data engine for collecting service parameters related to a service usage using a computer implemented facility, and a data normalization engine for normalizing the service parameters according to the defined service usage-related data types to generate a normalized service usage model. The data engine and the data normalization engine may repeat said collecting and normalizing periodically to determine the normalized service usage model on an updated basis. The parameters related to a service usage may be obtained from public information sources. The public information source may be a data feed file or a web crawl. The parameters related to a service usage may be obtained through direct connections to utility service providers. The parameters may be supplied, extracted, or input manually by the user to the computer implemented facility. The business rules server may prioritize the service usage-related data types prior to normalizing. The service parameter may be a user review or an adoption rate.

In an aspect of the invention, a machine readable medium may have program instructions stored thereon for comparing service plans based on a user's usage data executable by a processing unit. The program instructions may include collecting rewards program data for a user's rewards program using a computer implemented facility, analyzing the rewards program data to obtain a normalized value of rewards, receiving an indication of a rewards redemption, and calculating a user-specific value of rewards by multiplying a user-specific exchange rate by the normalized value of rewards. The exchange rate may relate to a currency system of the user's country or a different country. The rewards program data collected are at least one of periodic rewards earning, categories of rewards, current credit card, current rewards program, existing points balance, points expiration, and location. The rewards program data may be input manually by the user to the computer implemented facility. The rewards program data may relate to a predicted future earning. The rewards program data may be obtained for multiple rewards programs. The rewards program data may be automatically collected by the computer implemented facility. The rewards program data may include billing records. The billing records may be for a current bill only, historical billing data, or a paper bill. The computer implemented facility may utilize a secure retrieval application. Analyzing may include processing historical usage data to obtain an average value of rewards. Analyzing may include processing a single time period's usage data to obtain a value of rewards for that time period. The rewards redemption may relate to at least one of domestic airfare, international airfare, car rentals, cash, charitable donations, consumer electronics, cruises, hotel stays, restaurants, shopping, an item of value, a service, and a class of services. The class of services may be one of first class, business class, coach class, and premium class. The rewards type may be at least one of cash, points, certificates, vouchers, discounts, and miles.

In an aspect of the invention, a machine readable medium may have program instructions stored thereon executable by a processing unit. The program instructions may cause the machine to present a user-interface for performing a comparison of services, receive input from a user regarding a user's current service usage, wherein the service usage data are analyzed to obtain a normalized service usage dataset, and enable the user to review a plurality of alternative service offering normalized datasets generated by application of a normalized alternative service offering model to the normalized service usage dataset. The input may be a usage history provided by a user manually. The input may be login information required to automatically acquire a billing record from a service provider or third-party billing agent.

In an aspect of the invention, a machine readable medium may have program instructions stored thereon for comparing service plans based on a user's usage data executable by a processing unit. The program instructions may include collecting service usage data for a user's current service using a computer implemented facility, analyzing the service usage data to obtain a normalized service usage dataset, normalizing data related to a plurality of alternative service offerings according to a normalized alternative service offering model, applying the normalized alternative service offering model to the normalized service usage dataset to produce a plurality of alternative service offering normalized datasets, wherein the datasets comprise at least the cost for the alternative service offering, and comparing the alternative service offering normalized datasets to the normalized usage dataset according to at least one element of the datasets to determine if an alternative service offering is better than the user's current service. The program instructions may further include calculating an aggregate score for each of the plurality of alternative service offering normalized datasets. The aggregate score may include cost and at least one other element. The other element may be selected from the group consisting of total cost, per unit cost, savings, and service quality. The user may specify which aspects of the alternative service offering normalized dataset to include in the aggregate score. The program instructions may further include ranking the plurality of alternative service offering normalized datasets based on the aggregate score. The program instructions may further include collecting terms and conditions for the user's current service, analyzing the terms and conditions, calculating an aggregate score for the terms and conditions, and adding the aggregate score to the aggregate score for the normalized usage dataset. The program instructions may further include collecting terms and conditions for the alternative service offerings, analyzing the terms and conditions, calculating an aggregate score for the terms and conditions, and adding the aggregate score to the aggregate score for the alternative service offering normalized dataset. The program instructions may include collecting data points about the service offering and calculating the aggregate score based on those data points. The data points may be identified in the terms and conditions of the service offering. The data points may be in declarations related to the service offering. The data related to a plurality of alternative service offerings may be obtained from a data vendor. The data related to a plurality of alternative service offerings may be obtained from a human-assisted normalization system. The data related to a plurality of alternative service offerings may be obtained from public information sources. The data related to a plurality of alternative service offerings may be obtained through direct connections to service providers. The service usage data may be input manually by the user to the computer implemented facility. The service usage data may relate to a predicted future usage. The service usage data may be obtained for multiple services. The service usage data may include of average usage data over a specified period of time in the past.

The service usage data may be automatically collected by the computer implemented facility. The service usage data may include billing records. The billing records may be for a current bill only, historical billing data, a paper bill, or an electronic bill. The service usage data may be obtained independent of a user's billing data. The computer implemented facility may utilize a secure retrieval application. The service usage data are obtained for multiple services. The service usage data may be obtained from a user application. The application may be an online banking application, personal financial management software, a bill payment application, a check writing application, a logging application. The application may be a mobile phone usage logging application, a computer usage logging application, a browsing application, or a search application. Analyzing may include processing historical usage data to obtain an average normalized usage dataset or processing a single time period's usage data to obtain a normalized usage dataset for that time period. The program instructions may further include repeating said collecting, analyzing, normalizing, applying and comparing periodically to determine on an updated basis which alternative service offering is better than the user's current service. The program instructions may further include alerting the user when an alternative service offering that is better than the user's current service is available. Normalizing data related to the plurality of alternative service offerings may include defining a plurality of service usage-related data types, collecting parameters related to a service usage using the computer implemented facility, and normalizing the service parameters according to the defined service usage-related data types to generate a normalized alternative service offering model. The program instructions may further include enhancing the data or validating the data.

Comparing may include ranking the alternative service offerings according to an aspect of the alternative service offering normalized dataset. Comparing may include ranking the alternative service offerings according to an aggregate score calculated for the alternative service offering normalized dataset. The program instructions may further include plotting the aggregate score versus the cost for the alternative service offering. Comparing may include ranking the alternative service offerings according to cost. The program instructions may further include plotting the cost versus an aggregate score calculated for the alternative service offering. Comparing may compare ranking the alternative service offerings according to cost and an aspect of the alternative service offering normalized dataset. Comparing may include ranking the alternative service offerings according to total costs, per unit costs, and/or service quality. The user may be a business entity. When the service offering is a wireless service offering, the service usage data and data related to the alternative service offering may relate to at least one wireless service related item. When the service offering is a wireless service offering, the service usage data and data related to the alternative service offering may relate to at least one of plan definitions, add-on's, carrier coverage networks, cost, included minutes, plan capacity, additional line cost, anytime minutes, mobile-to-mobile minutes, minutes overage, nights & weekends minutes, nights start, nights end, roaming minutes, peak/off-peak minutes, data/downloads/applications charges, data overages, data megabytes used/unused, most frequently called numbers, most frequently called locations, networks/carriers called, calls per day, time of day usage, day of week usage, day of month usage, overages, unused services, carrier charges, messaging, messaging overage, activation fees, early termination fees, payment preferences, carrier, current hardware, compatible hardware, hardware availability, coverage area, signal strength, included services, caller ID block, call waiting, call forwarding, caller ID, voicemail, visual voicemail, 3-way calling, and insurance.

When the service offering is a credit card offering, the service usage data and data related to the alternative service offering may relate to at least one credit card related item. When the service offering is a credit card service, the service usage data and data related to the alternative service offering may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, and features and benefits. The redemption may relate to an item of value, a service, a class of services, domestic airfare, international airfare, car rentals, cash, charitable donations, consumer electronics, cruises, hotel stays, restaurants, or shopping. The class of services may be one of first class, business class, coach class, and premium class. The rewards type may be at least one of cash, points, certificates, vouchers, discounts, and miles. The features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, and travel insurance. The service offering may relate to at least one of wireless telephony, wireless data, internet service, hotel services, restaurant services, rental car services, loans, insurance services, auto loans, home loans, student loans, life insurance, home insurance, casualty insurance, auto insurance, motorcycle insurance, disability insurance, financial services, a credit card, a checking account, a savings account, a brokerage account, personal finance management, residential fuel, automotive fuel, a gym membership, a security service, television programming, VoIP, long distance calling, international calling, utilities, termite services, pest services, moving services, identity theft protection services, travel services, and software applications. The program instructions may further include enabling the user to purchase a selected service offering. The program instructions may further include enabling the user to contact a current service provider in order to modify their current service. The program instructions may further include presenting an advertisement to the user, wherein the advertisement is selected based on an alternative service offering.

In an aspect of the invention, a machine readable medium may have program instructions stored thereon for comparing service plans based on a user's usage data executable by a processing unit. The program instructions may include collecting service usage data for a user's current service using a computer implemented facility, analyzing the service usage data to obtain a normalized service usage dataset, applying a normalized alternative service offering model to the normalized service usage dataset to produce a plurality of alternative service offering normalized datasets, wherein the datasets comprise at least the cost for the alternative service offering, and comparing the alternative service offering normalized datasets to the normalized usage dataset according to at least one element of the datasets to determine if an alternative service offering is better than the user's current service.

In an aspect of the invention, a machine readable medium may have program instructions stored thereon for comparing service plans based on a user's usage data executable by a processing unit. The program instructions may include collecting service usage data for a user's current service using a computer implemented facility, analyzing the service usage data to obtain a normalized service usage dataset, applying a normalized alternative service offering model to the normalized service usage dataset to produce a plurality of alternative service offering normalized datasets, wherein the datasets comprise at least the cost for the alternative service offering, comparing the alternative service offering normalized datasets to the normalized usage dataset according to at least one element of the datasets to determine if an alternative service offering is better than the user's current service, and repeating said collecting, analyzing, normalizing, applying and comparing periodically to determine on an updated basis which alternative service offering is better than the user's current service.

In an aspect of the invention, a machine readable medium may have program instructions stored thereon for comparison shopping for insurance policies executable by a processing unit. The program instructions may include collecting insurance policy data for a user's current insurance policy using a computer implemented facility, analyzing the insurance policy data to obtain a normalized insurance policy dataset, normalizing data related to a plurality of alternative insurance policy offerings according to a normalized insurance policy offering model, applying the normalized insurance policy offering model to the normalized insurance policy dataset to produce a plurality of alternative insurance policy offering normalized datasets, and comparing the alternative insurance policy offering normalized datasets to the normalized insurance policy dataset to determine if an alternative insurance policy offering is better than the user's current insurance policy. The insurance policy data may include at least one of policy terms and conditions, policy cost, and policy benefits. The program instructions may further include analyzing the terms and conditions, calculating an aggregate score for the terms and conditions, and adding the aggregate score to the aggregate score for the normalized usage dataset. The program instructions may further include analyzing the terms and conditions, calculating an aggregate score for the terms and conditions, and adding the aggregate score to the aggregate score for the alternative insurance policy offering normalized dataset. The program instructions may further include calculating an aggregate score for each of the plurality of alternative insurance policy offering normalized datasets. The aggregate score may include cost and at least one other element. The other element may be selected from the group consisting of policy terms and conditions, policy cost, savings, and policy benefits. The program instructions may further include ranking the plurality of alternative insurance policy offering normalized datasets based on the aggregate score. The user may specify which aspects of the alternative insurance policy offering normalized dataset to include in the aggregate score. The insurance policy may be at least one of life insurance, auto insurance, health insurance, disability insurance, home insurance, and renter's insurance. The insurance policy data may be input manually by the user to the computer implemented facility, a predicted future usage, automatically collected by the computer implemented facility, or billing records. The billing records may be for a current bill, historical billing data, a paper bill, or an electronic bill. The computer implemented facility may utilize a secure retrieval application. The insurance policy data may include at least one of claims made against existing or recent policies, location of residence, make, model, and age of automobiles, driving records of insured parties, length of stay at current residence and employment or school, desired automobile, preference for future residence, and policy features such as towing services. The insurance policy data may be automatically collected by the computer implemented facility from at least one of an insurer and a government agency, property tax information, property value information, or a driving record. Analyzing may include processing historical insurance policy data to obtain a normalized insurance policy dataset that represents an average dataset. Analyzing may include processing a single time period's insurance policy data to obtain a normalized insurance policy dataset for that time period. The program instructions may further include repeating said collecting, analyzing, normalizing, applying and comparing periodically to determine on an updated basis which alternative insurance policy offering is better than the user's current insurance policy. Normalizing data related to the plurality of insurance policy offerings may include defining a plurality of insurance policy-related data types, collecting parameters related to an insurance policy using the computer implemented facility, and normalizing the insurance policy parameters according to the defined insurance policy-related data types to generate a normalized alternative insurance policy offering model. Comparing may include ranking the alternative insurance policy offerings according to cost. The program instructions may further include plotting the cost versus an aggregate score calculated for the alternative insurance policy. Comparing may include ranking the alternative insurance policy offerings according to an aspect of the alternative insurance policy offering normalized dataset. Comparing may include ranking the alternative insurance policy offerings according to cost and an aspect of the alternative insurance policy offering normalized dataset. The user may be a business entity. The program instructions may further include enabling the user to purchase a selected insurance policy offering. The program instructions may further include enabling the user to contact a current insurance policy provider in order to modify their current insurance policy. The program instructions may further include presenting an advertisement to the user, wherein the advertisement is selected based on an alternative insurance policy offering.

In an aspect of the invention, a machine readable medium may have program instructions stored thereon for comparing utility service plans based on a user's usage data executable by a processing unit. The program instructions may include collecting utility service usage data for a user's current utility service using a computer implemented facility, analyzing the utility service usage data to obtain a normalized utility service usage dataset, normalizing data related to a plurality of alternative utility service offerings according to a normalized alternative utility service offering model, applying the normalized alternative utility service offering model to the normalized utility usage dataset to produce a plurality of alternative utility service offering normalized datasets, and comparing the alternative utility service offering normalized datasets to the normalized utility service usage dataset to determine if an alternative utility service offering is better than the user's current utility service. The program instructions may further include calculating an aggregate score for each of the plurality of alternative utility service offering normalized datasets. The program instructions may further include ranking the plurality of alternative utility service offering normalized datasets based on the aggregate score. The user may specify which aspects of the alternative utility service offering normalized dataset to include in the aggregate score. The program instructions may further include collecting terms and conditions for the user's current service, analyzing the terms and conditions, calculating an aggregate score for the terms and conditions, and adding the aggregate score to the aggregate score for the normalized usage dataset. The program instructions may further include collecting terms and conditions for the alternative service offerings, analyzing the terms and conditions, calculating an aggregate score for the terms and conditions, and adding the aggregate score to the aggregate score for the alternative service offering normalized dataset. The data related to the plurality of alternative utility service offerings may be obtained from public information sources. The data related to the plurality of alternative utility service offerings may be obtained through direct connections to utility service providers. The utility service may be at least one of a natural gas, electric power, water, and residential fuel service. The utility service data may be input manually by the user to the computer implemented facility. The utility service data may be a predicted future usage, obtained for multiple utility services, automatically collected by the computer implemented facility, or billing records. The billing records may be for a current bill only, historical billing data, or a paper bill. The computer implemented facility may utilize a secure retrieval application. The utility service usage data may be obtained for multiple utility services. Analyzing may include processing historical utility service data to obtain a normalized utility service dataset that represents an average dataset. Analyzing may include processing a single time period's utility service data to obtain a normalized utility service dataset for that time period. The program instructions may further include repeating said collecting, analyzing, normalizing, applying and comparing periodically to determine on an updated basis which alternative utility service offering is better than the user's current utility service. Normalizing data related to the plurality of alternative utility service offerings may include defining a plurality of utility service usage-related data types, collecting parameters related to a utility service usage using the computer implemented facility, and normalizing the utility service parameters according to the defined utility service usage-related data types to generate a normalized alternative utility service offering model. Comparing may include ranking the alternative utility service offerings according to cost. Comparing may include ranking the alternative utility service offerings according to an aspect of the utility service offering normalized dataset. Comparing may include ranking the alternative utility service offerings according to cost and an aspect of the alternative utility service offering normalized dataset. The user may be a business entity. The program instructions may further include enabling the user to purchase a selected service offering. The program instructions may further include enabling the user to contact a current service provider in order to modify their current service. The program instructions may further include presenting an advertisement to the user, wherein the advertisement is selected based on an alternative service offering.

In an aspect of the invention, a machine readable medium may have program instructions stored thereon for comparing service plans based on a user's usage data executable by a processing unit. The program instructions may include collecting service usage data for a user's current service using a computer implemented facility, analyzing the service usage data to perform a billing error analysis and obtain a normalized service usage dataset, wherein the normalized service usage dataset is optionally corrected for any errors identified in billing, normalizing data related to a plurality of alternative service offerings according to a normalized alternative service offering model, applying the normalized alternative service offering model to the normalized service usage dataset to produce a plurality of alternative service offering normalized datasets, and comparing the alternative service offering normalized datasets to the normalized usage dataset to determine if an alternative service offering is better than the user's current service. The program instructions may further include notifying a service provider of an error in billing if an error is identified in analyzing the service usage data.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a block diagram of a consumer service comparison shopping system.

FIG. 2 depicts a flow diagram for comparing alternative service offerings.

FIG. 3 depicts an alternative service offering model.

FIG. 4 depicts a flow diagram for comparing alternative credit card offerings.

FIG. 5 depicts a flow diagram for comparing alternative credit card offerings according to a value of rewards.

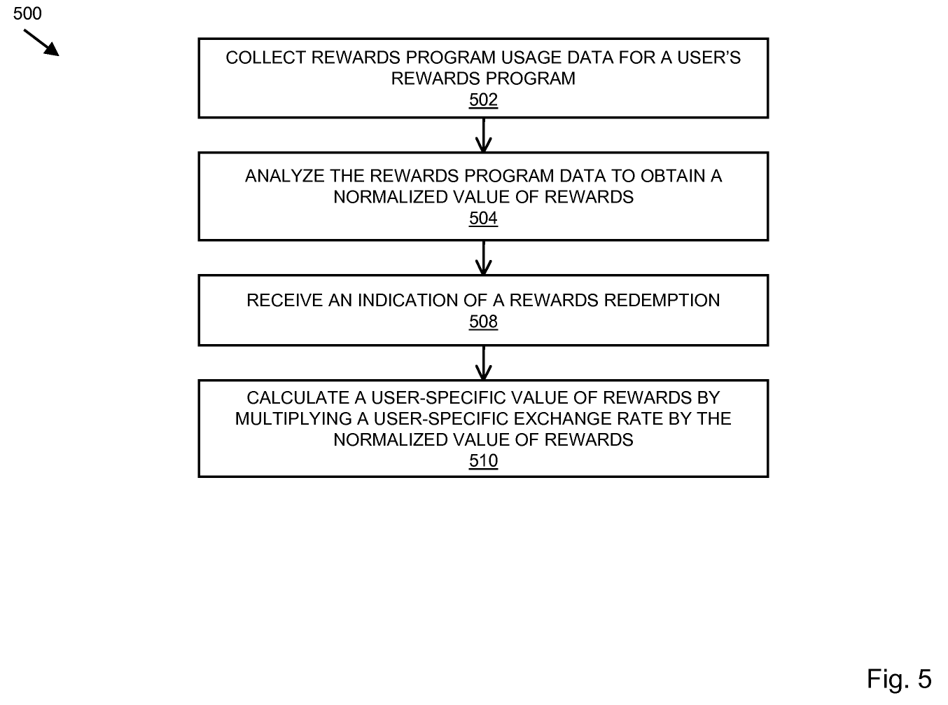

FIG. 6 depicts a flow diagram for comparing insurance policies.

FIG. 7 depicts a flow diagram for comparing alternative service offerings and performing a billing error analysis.

FIG. 8 depicts a flow diagram for determining a personalized true cost of service offerings.

FIG. 9 depicts a flow diagram of a process for normalizing user data.

FIG. 10 depicts a flow diagram of a process for generating a normalized service usage model.

FIG. 11 depicts a flow diagram of a method for comparing alternative wireless service offerings.

FIG. 12 depicts a flow diagram of a method for comparing savings account offerings.

FIG. 13 depicts a flow diagram of a method for comparing internet, television, and telephone service offerings.

### DETAILED DESCRIPTION

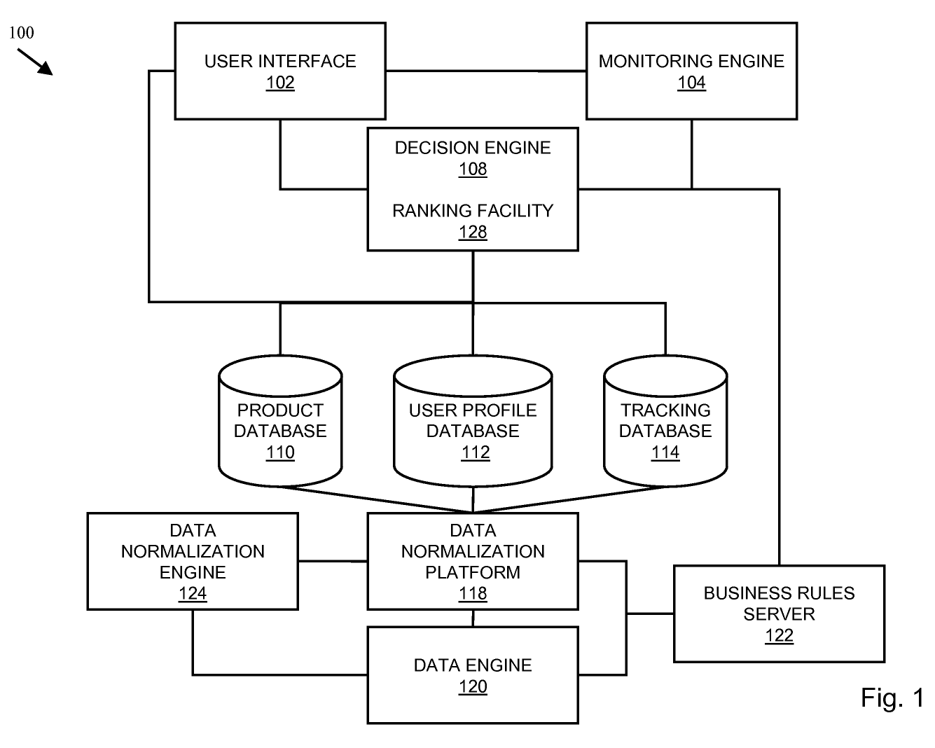

Referring to FIG. 1, an embodiment of a consumer service comparison shopping system 100 is depicted. Through the user interface 102, a user may access the decision engine 108 and monitoring engine 104. In an embodiment, the user interface 102 may be embodied in a website. The user may enter service usage data and preference data into a user profile database 112. For example, the data may include a geographical location, a current service provider, a current service cost, a current service usage, a predicted future service usage, preferences for future service, and other pertinent information. In an alternative embodiment, the data may be gathered automatically from the user's service provider by a data engine 120, such as by logging in to a user's service account after obtaining authorization from the user for release of such information. The data normalization platform 118 may normalize data obtained from the user and stored in the user profile database 112, data obtained about the user's service usage using the data engine 120, as well as alternative service offering data stored in a product database 110. A data normalization engine 124 may perform the normalization step. The decision engine 108 may utilize the usage and preference data from the consumer along with the business rules server 122 to determine how the user's needs, based on a previous or predicted future usage, and preferences match with alternate service offerings offered by various service providers. The decision engine 108 may organize the usage data based on the business rules server 122, and then determines how well each service offering fits the user based on one or more factors, such as total cost, per unit cost, service quality, and the like. The user may then be given the option to select an alternative service offering based on the recommendation by the decision engine 108. The user may be given the option to proceed to acceptance of terms and conditions as well as payment for services. In an embodiment, the monitoring engine 104 may repeat the process of obtaining and normalizing alternative service offering data and comparing it to the user's needs and preferences to determine on an updated basis which alternative service offering best fits the user's needs and preferences. The tracking criteria and output of the monitoring engine 104 may be stored in the tracking database 114. For example, the monitoring engine 104 may repeat the process when a new service offering becomes available, when a user's service usage changes, when a user moves to a new geographic location, when a user indicates a desire to do so, and the like. The user may be alerted when the process is repeated.

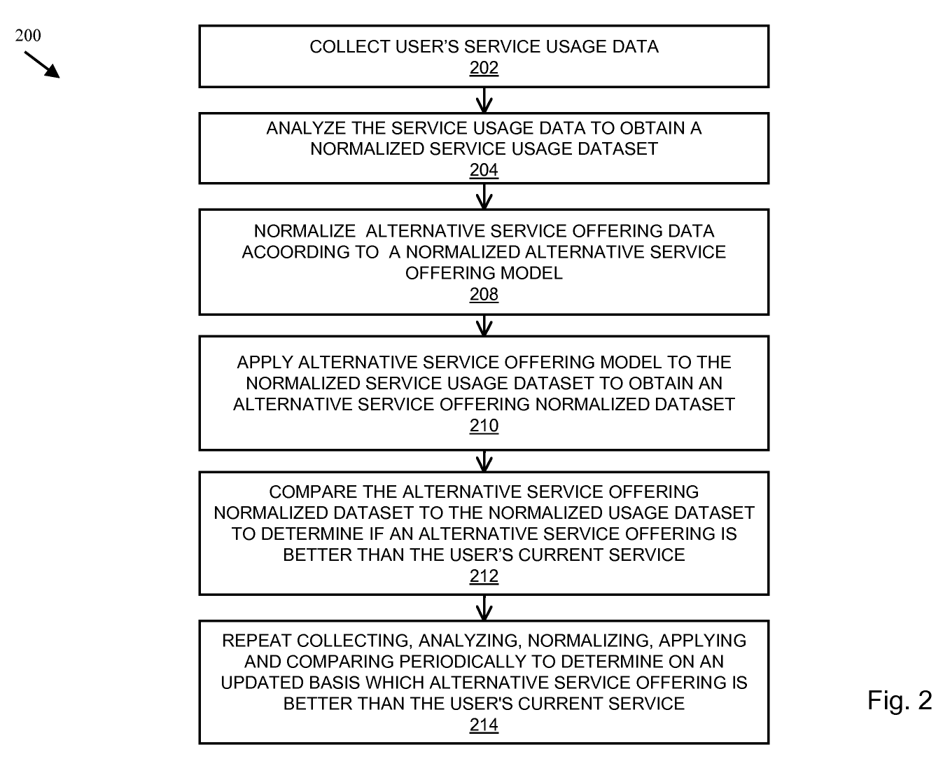

Referring now to FIG. 2, a method of comparing service plans based on a user's service usage data may include the steps of collecting service usage data for a user's current service using a computer implemented facility 202, analyzing the service usage data to obtain a normalized service usage dataset 204, optionally, normalizing data related to a plurality of alternative service offerings according to a normalized alternative service offering model 208, applying the normalized alternative service offering model to the normalized service usage dataset to produce a plurality of alternative service offering normalized datasets, wherein the dataset comprises at least the cost for the alternative service offering 210, comparing the alternative service offering normalized datasets to the normalized usage dataset to determine if an alternative service offering is better than the user's current service 212, and optionally, repeating said collecting, analyzing, normalizing, applying and comparing periodically to determine on an updated basis which alternative service offering is better than the user's current service 214. It should be understood that the methods and systems described herein may be applicable to any service plan, policy, or offering engaged in by a user. For example, the service offering may relate to wireless telephony, wireless data, internet service, hotel services, restaurant services, rental car services, loans, insurance services, auto loans, home loans, student loans, life insurance, home insurance, casualty insurance, auto insurance, motorcycle insurance, disability insurance, financial services, a credit card, a checking account, a savings account, a brokerage account, an insurance policy, utility service, personal finance management, residential fuel, automotive fuel, a gym membership, a security service, television programming, VoIP, long distance calling, international calling, utilities, termite services, pest services, moving services, identity theft protection services, travel services, software applications, and the like. For example, in the case where the service offering is travel services, the system 100 may obtain information about a user's previous travel, such as what hotels they have stayed at and what level of service is offered by the hotel, what level of service the user purchases for flights, what type of car the user has rented, if the user pre-purchases tour packages, and the like. When the user requests that the system determine a new travel offering, the system may search for accommodations based on at least one aspect of the user's previous travel. The user's previous travel may be analyzed to obtain a normalized travel service usage dataset which may be compared to an alternative service offering normalized dataset to determine a travel service offering for the user.

In an embodiment, collecting service usage data for a user's current service using a computer implemented facility 202 may comprise the service usage data being input manually by the user to the computer implemented facility. For example, using the user interface 102, a wireless service user may indicate their service usage data, such as how much they spend a month, how many anytime minutes they use, how many wireless lines they have, if they send text, video, or MMS messages, how frequently they message, their geographic locations of use, and the like. The service usage data may be for a current use, past use, or a predicted future use. The service usage data may relate to more than one service plan. In an embodiment, the service usage data may relate to a single service usage parameter. In an alternative embodiment, the service usage data may be obtained automatically, such as with a secure retrieval application. For example, the user may give permission for the data engine 120 to log into the user's service account and obtain the service usage data. In an embodiment, the service usage data are obtained from usage records or billing records, either current or historical. In some embodiments, the data engine 120 obtains a copy of a bill and processes it to obtain the service usage data. The service usage data may relate to more than one service plan. In an alternative embodiment, the service usage data are obtained from an application. For example, the application may be an online banking application, personal financial management software, a bill payment application, a check writing application, a logging application, a mobile phone usage logging application, a computer usage logging application, a browsing application, a search application, and the like. The service usage data may consist of average usage data over a specified period of time in the past. The service usage data may be obtained independent of a user's billing data.

In an embodiment, analyzing the service usage data to obtain a normalized service usage dataset 204 may comprise processing historical usage data to obtain an average normalized usage dataset. Alternatively, processing a single time period's usage data may be done to obtain a normalized usage dataset for that time period. Normalizing usage data may be done by sorting the data according to service-related data types used to define a data model. In an embodiment, the data are sorted according the same data types used in the normalized alternative service offering model to facilitate applying the normalized alternative service offering model to the usage data

In an embodiment, normalizing data related to a plurality of alternative service offerings may be done according to a normalized alternative service offering model. The data engine 120 is programmed to extract data related to alternative service offerings from multiple sources, some of which may be human-generated. For example, the data engine 120 may be programmed to know the location of rate plan data on a wireless carrier's website. The data related to the plurality of alternative service offerings may be obtained from a data vendor, a human-assisted normalization system, public information sources, direct connections to service providers, and the like. The data then are normalized according to an alternative service offering model. Normalizing data related to the plurality of alternative service offerings may include defining a plurality of service usage-related data types, such as number of peak minutes available, number of nights and weekend minutes available, and the like, collecting parameters related to a service usage using the computer implemented facility, such as how many minutes were used during a particular time period, and normalizing the service parameters according to the defined service usage-related data types to generate a normalized alternative service offering model. The data engine 120 may sort all of the data it collects for each plan and its potential add-on's according to the normalized alternative service offering model. As the data are collected from various sources, it is integrated according to the normalized alternative service offering model. Normalization occurs via at least one of two methods, semantic normalization, syntactic normalization, and the like. In semantic normalization, a string of characters or set of words, phrases, number, and the like may be determined to mean something specific in the data model. Semantic normalization may be done by human encoding, where humans decide the semantic meaning, or may be done in an automated fashion. For example, the normalized alternative service offering model may have only a field for afternoon rates, but a provider's rate plan segments the day according to chunks of hours, such as from 1 pm-4 pm, and the like. The data normalization platform 118 may examine the data from the service provider and determine that the 1 pm-4 pm time period rate should be described as an afternoon rate in the normalized alternative service offering model. The assignment of the provider's rate time period to a particular field of the normalized alternative service offering model may only need to be done once in order for the data normalization platform 118 to know how to interpret the data every time it pulls data automatically, such as for updating, from the service provider. In syntactic normalization, the data normalization platform 118 possesses certain information to convert certain patterns to others. For example, the data normalization platform 118 can extract the 1 pm to 2 pm time period and assign it to Hour A, extract the 2 pm to 3 pm time period and assign it to Hour B, extract the 3 pm to 4 pm time period and assign it to Hour C, and so on. In an embodiment, the data may be enhanced or validated prior to normalization.

In an embodiment, a canonical model for the user data may be defined manually. Then, an agent, or data engine, may be defined or taught so it knows how to map data from a given source into the canonical model. The data engine may be automated from then on. The data engine is taught by a human how to read the data, then convert that into a global concept, such as a model of a cell phone bill. Then the data engine may be instructed to run on a specific item, such as a bill from VERIZON, to pull data and map the data to a canonical model.

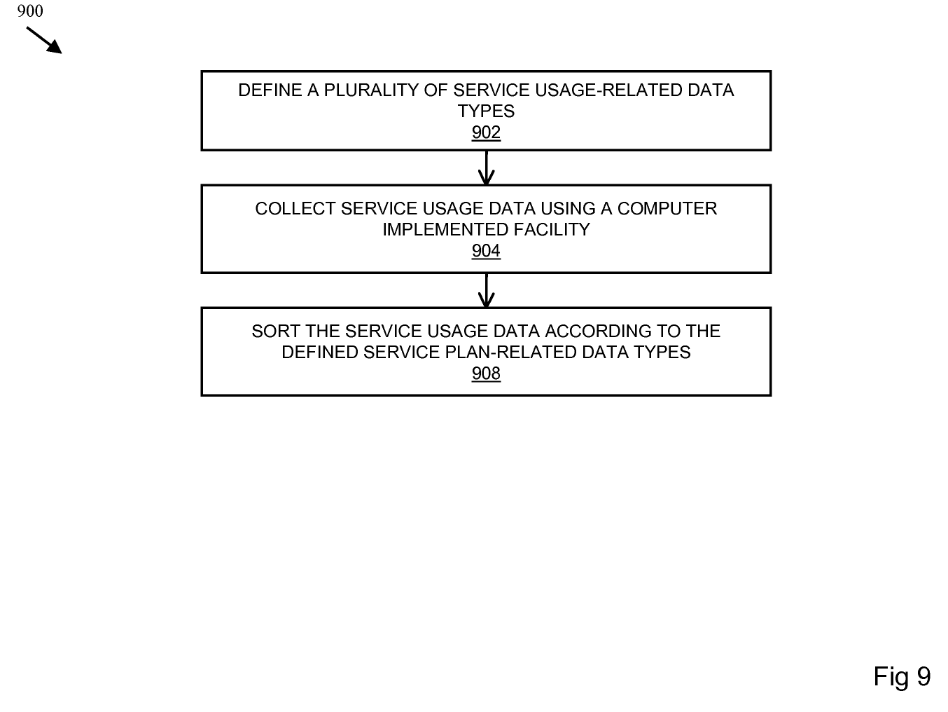

Referring to FIG. 9, a process for normalizing user data may include defining a plurality of service usage-related data types 902, collecting service usage data using a computer implemented facility 904, and sorting the service usage data according to the defined service plan-related data types 908.

In an embodiment, the business rules server 122 may enhance and/or validate the normalized data, either the normalized service usage dataset or the normalized alternative service offering dataset, and/or the normalized alternative service offering model. Rules may be applied to the datasets or model, such as rules regarding a given vertical, rules based on facts about a rate plan, add-on's, phones or devices, their relative importance in determining the best plan or an aggregate score, information about the user, information about similar users, and the like. The business rules server 122 may verify that the datasets and/or model fit known facts and heuristics stored in the business rules server 122.

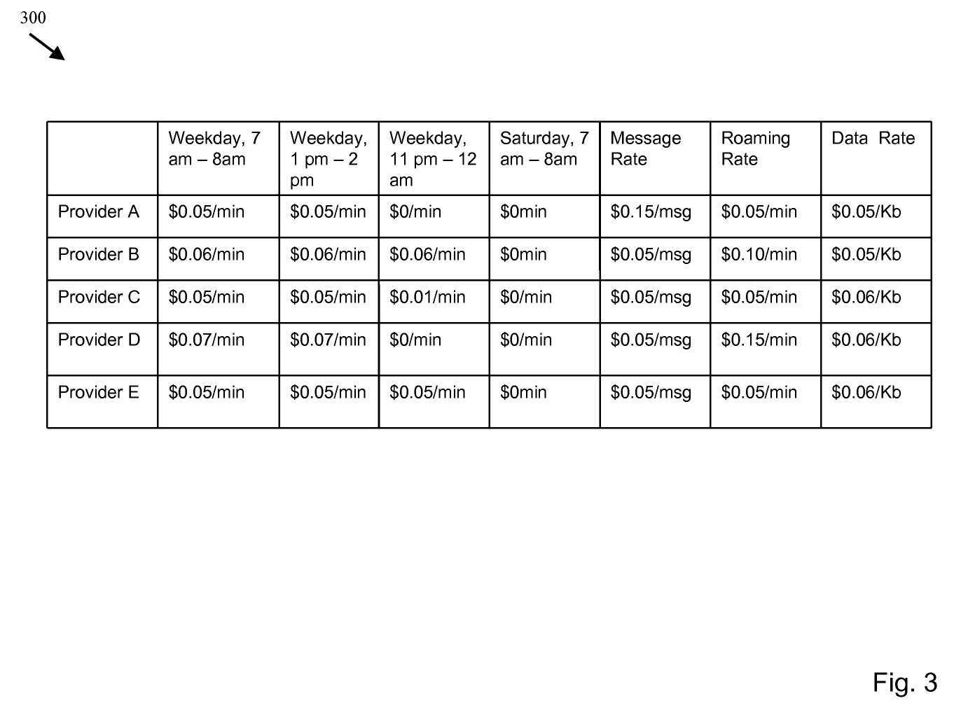

In an embodiment, producing a plurality of alternative service offering normalized datasets may comprise applying the normalized alternative service offering model to the normalized service usage dataset. In some embodiments, the alternative service offering normalized datasets comprise at least the cost for the alternative service offering. The normalized alternative service offering model is applied to the normalized service usage dataset in order to determine what the cost of a particular alternative service offering would be given the user's service usage. For example, the normalized alternative service offering model may be envisioned as a matrix 300. For example, in FIG. 3, an embodiment of a model in the form of a matrix is shown. In this example and without limitation, the model is for wireless plans and comprises a Weekday, 7 am-8 am rate, a Weekday, 1 pm-2 pm, a Weekday, 11 pm-12 am rate, a Saturday 7 am-8 am rate, a messaging rate, a roaming rate, and a data rate. A person of skill in the art will understand that the model may include any defined data types, such as data by the hour, by ranges of time, by day, by weekend, and the like. Data may be acquired from each provider with regard to what their rates are during the defined time periods. For example, Provider A's Weekday, 7 am-8 am rate is $0.05/min while Provider D's is $0.07/min. The message rate for Provider A is $0.15/msg while Provider D's is $0.05/msg.

In an embodiment, determining if an alternative service offering is better than the user's current service may comprise comparing the alternative service offering normalized datasets to the normalized usage dataset. Applying the model to the usage data may comprise the decision engine 108 multiplying the number of minutes or messages used during the time period by the rate during the time period. If the data normalization platform 118 determined that 100 calls were made during the Weekday 7 am-8 am time period and the user sent and/or received 100 text messages, the cost for the Current Provider A, if only these two data types were considered, would be $20 while Provider D would be $12. The decision engine 108 may determine that given the user's service usage, the service offering from Provider D may be a better fit to the user given the lower cost. In an alternative embodiment, the data engine 120 may have pulled additional information, such as the opportunity to purchase an unlimited message plan, and placed it in the matrix 300. Therefore, when the model is applied to the service usage data, the decision engine 108 may perform an optimization with respect to messaging, calculating if it is cheaper to go with the pay-as-you-go plan or getting unlimited messaging. Continuing with the above example, if Current Provider A offered a flat rate for messaging of $5 per month while Provider D only offered the pay-per-message rate structure, the decision engine 108 optimization may result in Current Provider A offering the service offering with the better fit to the user given the lower cost of Current Provider A's service ($10) versus Provider D's service ($12). In this case, the user may be advised to not change their service provider but perhaps ask the provider to add on the flat message rate feature.

Cost may be only one component in determining if an alternative service offering is better than the user's current service. User preference, signal strength, terms and conditions, and the like may all be components of determining if an alternative service offering is better than the user's current service. In an embodiment, the decision engine 108 may perform a personalized impact analysis. The decision engine 108 may compute an aggregate score for each alternative service offering normalized dataset. For example, when the service offering is a wireless service, the aggregate score may include a normalization of the alternative service offering savings and signal strength. In an example, the data engine 120 may extract usage information then map the usage onto a wireless plan. In embodiments, the wireless plan may also have optional add-on's and Term's & Condition's added into the calculation for aggregate score. For any given service, the decision engine 108 may be able to select the best possible option from a range of service plans. Then, the decision engine 108 may be able to select optimal add-on's to achieve the lowest impact, or the best aggregate score. In embodiments, the user may be able to specify what criteria to include in the aggregate score calculation. In the case of wireless plans, wireless coverage or signal strength may also be a component of the aggregate score. Individual scores attributed to components of the service may be added together, often in a non-trivial formula, to weight them and come up with an aggregate score. For example, a score may be assigned to term's and condition's, a score may be assigned to signal strength, a score may be assigned to savings over a current service plan, and the like. Users may be able to set the weighting, such as with a slider or manually. Alternatively, certain assumptions may be be made in providing an automatic weighting. Assumptions may be provided and stored on the business rules server 122.

The aggregate score may include cost and at least one other element. The other element may be selected from the group consisting of total cost, per unit cost, savings, and service quality. The instruction may further include collecting data points about the service offering and calculating the aggregate score based on those data points. The data points may be identified in the terms and conditions of the service offering. The data points may be in declarations related to the service offering.

In an embodiment, once an aggregate score is calculated, the alternative service plans may be ranked, such as according to aggregate score, according to savings, according to signal strength, according to a combination of the above, and the like, in order to compare the various alternative service plans. In some embodiments, the aggregate score may be plotted according to the overall cost of the service plan. In some embodiments, comparing service plans includes ranking the alternative service offerings according to total costs, per unit costs, and service quality or signal strength.

In an embodiment, after comparing service plans, the user may have the option to purchase a service plan or contact a current service provider in order to modify their current service.

In an embodiment, at any point during the process of collecting 202, analyzing 204, normalizing 208, applying 210 and comparing 212, an advertisement may be presented to the user, wherein the advertisement is selected based on an alternative service offering.

In an embodiment, the system 100 may repeat 214 the steps of collecting 202, analyzing 204, normalizing 208, applying 210 and comparing 212 periodically to determine on an updated basis which alternative service offering is better than the user's current service. The user may be alerted when an alternative service offering that is better than the user's current service is available, such as by email, phone, SMS, MMS, and the like. The repetition interval may be set by the user or may be a pre-determined system 100 interval. The user may also be alerted that the repetition 214 is occurring.

In an embodiment, the user may be a business entity.

In an embodiment, when the service offering is a wireless service offering, the service usage data and data related to the alternative service offering may relate to at least one of plan definitions, add-on's, carrier coverage networks, cost, included minutes, plan capacity, additional line cost, anytime minutes, mobile-to-mobile minutes, minutes overage, nights & weekends minutes, nights start, nights end, roaming minutes, peak/off-peak minutes, data/downloads/applications charges, data overages, data megabytes used/unused, most frequently called numbers, most frequently called locations, networks/carriers called, calls per day, time of day usage, day of week usage, day of month usage, overages, unused services, carrier charges, messaging, messaging overage, activation fees, early termination fees, payment preferences, carrier, current hardware, compatible hardware, hardware availability, coverage area, signal strength, included services, caller ID block, call waiting, call forwarding, caller ID, voicemail, visual voicemail, 3-way calling, insurance, at least one wireless service related item. and the like. Any of the aforementioned service usage data types may be used to calculate an aggregate score, in comparing service offerings, in ranking service offerings, and the like.

In an embodiment, when the service offering is a credit card service, the service usage data and data related to the alternative service offering may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, features and benefits, at least one credit card related item and the like. For example, typical redemptions may include domestic airfare, international airfare, car rentals, cash rebates, charitable donations, consumer electronics, cruises, hotel stays, restaurants, shopping, and the like. The redemption may relate to an item of value, a service, and a class of services. The class of services may be one of first class, business class, coach class, and premium class.

A user may weight the availability of domestic airfare redemption options higher than the option of receiving a cash rebate, and the weighting may be used to rank credit card offerings accordingly. In another example, the rewards type may be at least one of cash, points, certificates, vouchers, discounts, and miles. In another example, the features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, travel insurance, and the like. Any of the aforementioned credit card data types may be used to calculate an aggregate score, in comparing credit card offerings, in ranking credit card offerings, and the like.

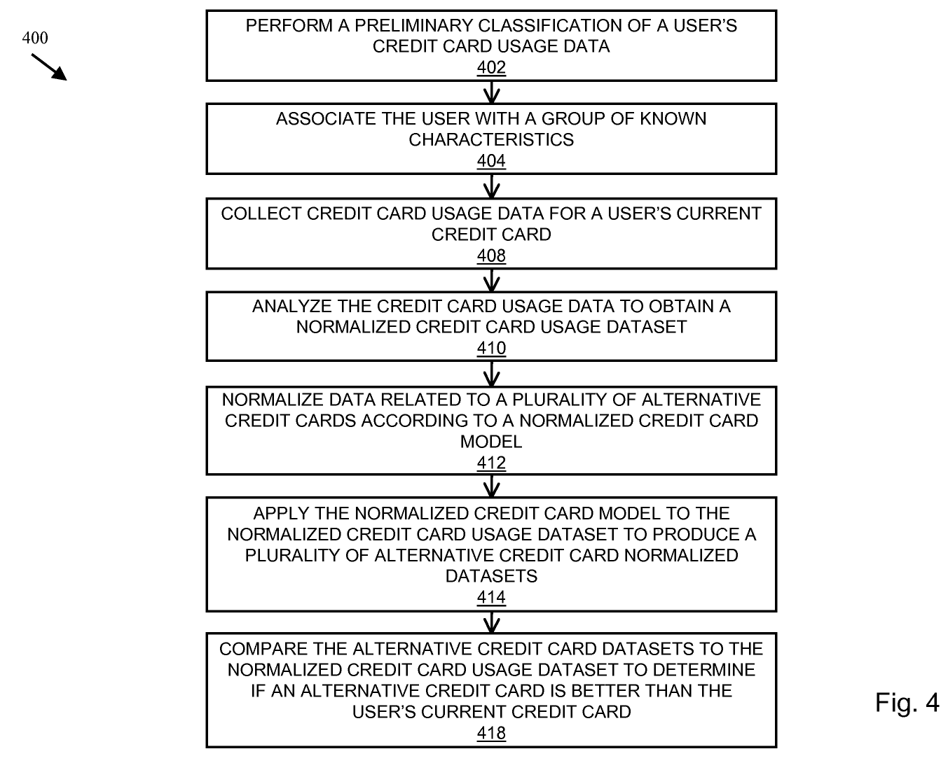

Referring now to FIG. 4, in embodiments, the service offering may be a credit card offering. When the service offering is a credit card offering, a preliminary classification of a user's credit card usage data 402 may be performed to associate the user with a group of known characteristics 404. For example, the group may be those that pay their credit cards off every month, those that carry a balance, and the like. In an example, if the user pays off their balance every month, the credit card usage data collected in subsequent steps may include monthly spending, credit rating, categories of spending, current credit card, number of years holding current credit card, and the like. In another example, if the user does not pay off their balance every month, the credit card usage data collected may be monthly spending, credit rating, categories of spending, current credit card, number of years holding current credit card, existing balance, interest rate, late payments, monthly payment, and the like. After associating the user with a group of known characteristics 404, credit card usage data may be collected for a user's current credit card 408 using a computer implemented facility according to the preliminary classification. The credit card usage data may be analyzed to obtain a normalized credit card usage dataset 410. Analyzing may include processing historical usage data to obtain an average normalized usage dataset, processing a single time period's usage data to obtain a normalized usage dataset for that time period, and the like. Data related to a plurality of alternative credit cards may be normalized according to a normalized credit card model 412. Normalizing data related to the plurality of alternative credit cards may include defining a plurality of credit card usage-related data types, collecting parameters related to a credit card usage using the computer implemented facility, and normalizing the credit card parameters according to the defined credit card usage-related data types to generate a normalized alternative credit card model. Then, the normalized credit card model may be applied to the normalized credit card usage dataset to produce a plurality of alternative credit card normalized datasets 414. A comparison of the alternative credit card datasets with the normalized credit card usage dataset may reveal if an alternative credit card is better than the user's current credit card 418. Comparing may include ranking the alternative credit cards according to an aggregate score calculated for the alternative credit card normalized dataset, an aspect of the alternative credit card normalized dataset, and the like. In an embodiment of comparing, the aggregate score may be plotted against the cost for the alternative credit card. The aspect may be the total card cost, a value of rewards, an additional earnings over the user's current credit card, a savings over the user's current credit card, at least one of an introductory purchase APR, an introductory rate period, a purchase APR, an annual fee, a balance transfer fee, and a credit level required, at least one of a reward type, a rewards sign-up bonus, a base earning rate, a maximum earning rate, and an earning limit, and the like. As described previously, an aggregate score for each of the plurality of alternative credit card normalized datasets may be calculated, where the score may be used for ranking. As described previously, users may specify which components of the dataset or terms & conditions to include in the calculation for the aggregate score and with what weighting to include them. Credit card data, both usage and alternative credit cards, may be obtained from public information sources, direct connections to credit card providers, automatically, input manually by the user to a computer implemented facility for a current card usage or predicted future credit card usage, chosen by a user from among a sampling of standard credit card profiles, for multiple credit cards, and the like. In some embodiments, credit card usage data may be obtained by the data engine 120 in a computer readable format, such as in a billing record. The billing record may be for a current bill only, may be historical billing data, may be a paper bill, an electronic bill, and the like. Once the user may have compared various credit card offerings, they may be provided the option of applying for a selected credit card, contact a current credit card provider in order to modify their current credit card terms and conditions, and the like.

In an embodiment, at any point during the process of performing 402, associating 404, collecting 408, analyzing 410, normalizing 412, applying 414 and comparing 418, an advertisement may be presented to the user, wherein the advertisement is selected based on an alternative service offering.

In an embodiment, the system 100 may repeat the steps of performing 402, associating 404, collecting 408, analyzing 410, normalizing 412, applying 414 and comparing 418 periodically to determine on an updated basis which alternative service offering is better than the user's current service. The user may be alerted when an alternative service offering that is better than the user's current service is available, such as by email, phone, SMS, MMS, and the like. The repetition interval may be set by the user or may be a pre-determined system 100 interval. The user may also be alerted that the repetition is occurring.

In an embodiment, the user may be a business entity.

In an embodiment, the credit card usage data and data related to the alternative credit card may relate to at least one of monthly spending, spending categories, credit rating, current credit card, years of use of credit card, current balance, monthly pay-off amount, current APR, pay off every month, carry a balance, sign-up bonus, bonus rewards, base earning rate, maximum earning rate, earning limit, total value of rewards, earned program promotions, spend program promotions, net asset promotions, annual fee, late fee, balance transfer fee, cash advance fee, purchases APR, introductory APR, regular APR, penalty APR, balance transfer APR, cash advance APR, typical redemptions, redemption options, rewards type, credit card network, credit card issuer, features and benefits, and the like. For example, typical redemptions may be for domestic airfare, international airfare, car rentals, cash, charitable donations, consumer electronics, cruises, hotel stays, restaurants, and shopping. The rewards type may be one of cash, points, and/or miles. The features and benefits may include at least one of instant approval, no annual fee, secured card, no fraud liability, 24 hr. customer service, airport lounge access, auto rental insurance, concierge service, emergency replacement, extended warranty, online account management, photo security, price protection, purchase protection, return protection, roadside assistance, travel insurance, and the like.

In an alternative embodiment, credit card usage data may be analyzed to obtain a value of rewards. For example, credit card usage data for a user's current credit card may be collected 502, such as by using a computer implemented facility. Then the data may be analyzed to obtain a value of rewards 504. An indication of a rewards redemption may be received 508. A user-specific value of rewards may be calculated by multiplying a user-specific exchange rate by the normalized value of rewards 510. In addition to the rewards program data described herein, information related to calculating a value of rewards may also be collected 502. Analyzing 504 may include processing historical usage data to obtain an average value of rewards, processing a single time period's usage data to obtain a value of rewards for that time period, and the like. The exchange rate may relate to the currency system of the user's country or a different country. The system 1000 may Page: 36

[0] automatically compare the value of rewards in different currencies because the system 100 may be able to convert the value of a reward point to a dollar in a personalized way. The personalized exchange rate for you may depend on what the user wants to redeem the points for. For example, redemption outside the user's country might have much more value than redemption inside the user's country. In the example, a user might get as much as 4 cents per point as compared to 0.5 cents per point depending on what, and where, the user redeems the points. Certain currencies, for example, may be more valuable to one user when compared to another user.

In an embodiment, the system 100 may repeat the steps of collecting 502, analyzing 504, receiving 508, and calculating 510 periodically to determine on an updated basis a user-specific value of rewards. The user may be alerted when a reward of a different or particular value is available, such as by email, phone, SMS, MMS, and the like. The repetition interval may be set by the user or may be a pre-determined system 100 interval. The user may also be alerted that the repetition is occurring.

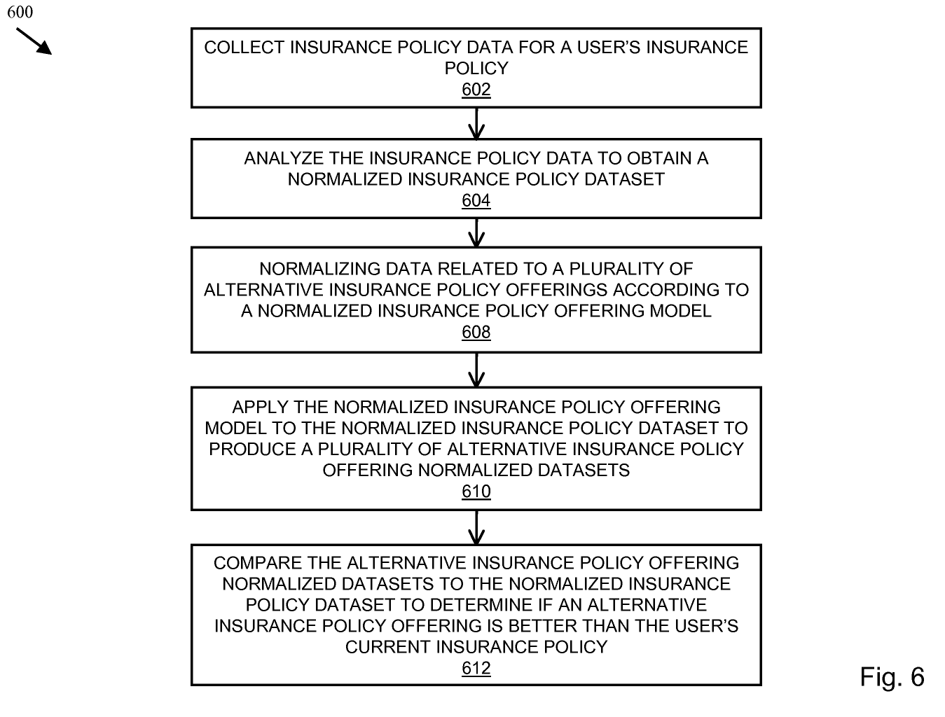

Referring to FIG. 6, when the service offering relates to an insurance policy, data for a user's current insurance policy may be collected using a computer implemented facility 602. The insurance policy may be at least one of life insurance, auto insurance, health insurance, disability insurance, home insurance, and renter's insurance. Then, the insurance policy data may be analyzed to obtain a normalized insurance policy dataset 604. Analyzing may include processing historical insurance policy data to obtain a normalized insurance policy dataset that represents an average dataset, or processing a single time period's insurance policy data to obtain a normalized insurance policy dataset for that time period. Data related to a plurality of alternative insurance policy offerings may be normalized according to a normalized insurance policy offering model 608. Normalizing data related to the plurality of insurance policy offerings may include defining a plurality of insurance policy-related data types, collecting parameters related to an insurance policy using the computer implemented facility, and normalizing the insurance policy parameters according to the defined insurance policy-related data types to generate a normalized alternative insurance policy offering model. The normalized insurance policy offering model may be applied to the normalized insurance policy dataset to produce a plurality of alternative insurance policy offering normalized datasets 610. Then, the alternative insurance policy offering normalized datasets may be compared with the normalized insurance policy dataset to determine if an alternative insurance policy offering is better than the user's current insurance policy 612. Comparing may include ranking the alternative insurance policy offerings according to cost, plotting the cost versus an aggregate score calculated for the alternative insurance policy, ranking the alternative insurance policy offerings according to an aspect of the alternative insurance policy offering normalized dataset, ranking the alternative insurance policy offerings according to cost and an aspect of the alternative insurance policy offering normalized dataset, and the like. Insurance policy data may include at least one of policy terms and conditions, policy cost, policy benefits, claims made against existing or recent policies, location of residence, make, model, and age of automobiles, driving records of insured parties, length of stay at current residence and employment or school, desired automobile, preference for future residence, policy features such as towing services property tax information, property value information, a driving record, property tax information, and the like. Insurance policy data may be input manually by the user to the computer implemented facility, may be a predicted future usage, may be automatically collected by the computer implemented facility, may include comprise billing records, may be automatically collected by the computer implemented facility from at least one of an insurer and a government agency, and the like. The billing records may be for a current bill only, historical billing data, a paper bill, and the like. In an embodiment, the program instructions further include analyzing the terms and conditions, calculating an aggregate score for the terms and conditions, and adding the aggregate score to the aggregate score for the normalized usage dataset or alternative insurance policy offering normalized dataset. In an embodiment, the program instructions further include calculating an aggregate score for each of the plurality of alternative insurance policy offering normalized datasets. In an embodiment, the program instructions further include ranking the plurality of alternative insurance policy offering normalized datasets based on the aggregate score. The user may specify which aspects of the alternative insurance policy offering normalized dataset to include in the aggregate score. In an embodiment, the system 100 may repeat the steps of collecting 602, analyzing 604, normalizing 608, applying 610 and comparing 612 periodically to determine on an updated basis which alternative insurance policy is better than the user's current insurance policy. The user may be alerted when an alternative insurance policy that is better than the user's current insurance policy is available, such as by email, phone, SMS, MMS, and the like. The repetition interval may be set by the user or may be a pre-determined system 100 interval. The user may also be alerted that the repetition is occurring. In an embodiment, the user may be a business entity. After the program instructions have been completed, the user may have the option to purchase a selected insurance policy offering, contact a current insurance policy provider in order to modify their current insurance policy, and the like. In an embodiment, an advertisement may be presented to the user, wherein the advertisement is selected based on an alternative insurance policy offering.

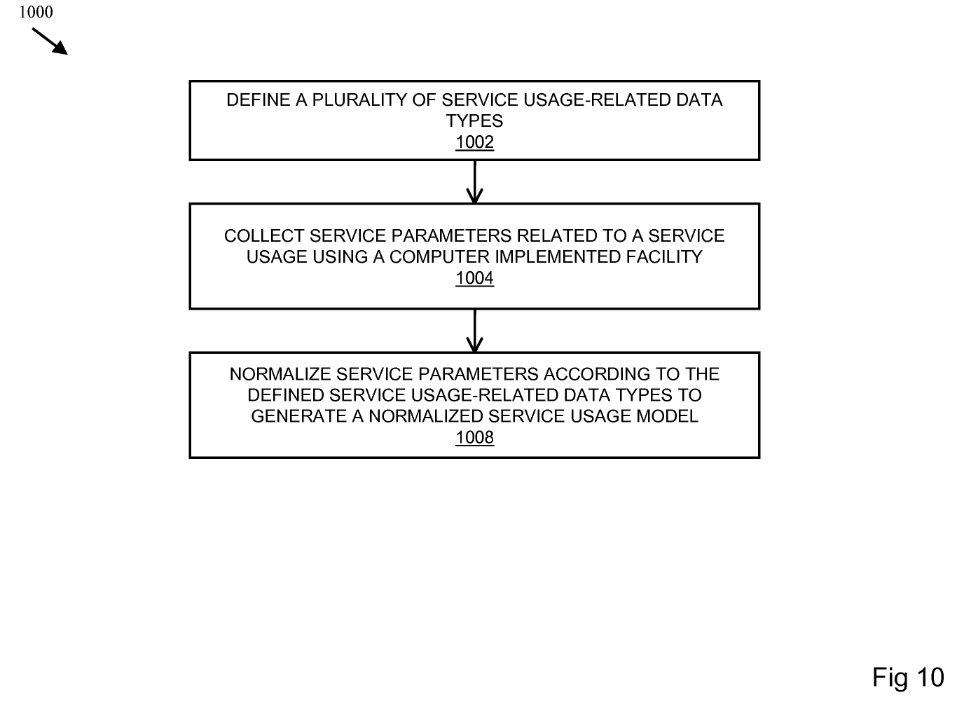

In an embodiment, a data normalization platform 118 for generating a normalized service usage model may include a business rules server 122 for storing the definitions of a plurality of service usage-related data types, a data engine 120 for collecting service parameters related to a service usage using a computer implemented facility, and a data normalization engine 124 for normalizing the service parameters according to the defined service usage-related data types to generate a normalized service usage model. In FIG. 10, a flow diagram of a process for generating the normalized service usage model is shown. In the process, a plurality of service usage-related data types are defined 1002. Then, service parameters related to a service usage are collected using a computer implemented facility 1004. The service parameters are then normalized according to the defined service usage-related data types to generate a normalized service usage model 1008. The entire process may be repeated periodically to update the normalized service usage model. The data engine 120 and the data normalization engine 124 may repeat said collecting and normalizing periodically to determine the normalized service usage model on an updated basis. The parameters related to a service usage may be obtained from public information sources. The public information source may be a data feed file. The public information source may be a web crawl. The parameters related to a service usage may be obtained through direct connections to utility service providers, may be supplied, may be extracted, may be input manually by the user to the computer implemented facility, and the like. The business rules server 122 may prioritize the service usage-related data types prior to normalizing. The service parameter may be a user review. The service parameter may be an adoption rate.

In an embodiment, estimating the cost of an alternative service may include a decision engine 108 for applying a normalized alternative service offering model to a normalized service usage dataset to produce a plurality of alternative service offering normalized datasets, and a ranking facility 128 for comparing the alternative service offering normalized datasets to the normalized usage dataset to determine if an alternative service offering is better than the user's current service. In embodiments, the ranking facility 128 may be an integral part of the decision engine 108. The ranking facility 128 may optionally consider weights of certain dataset factors in comparing datasets. The ranking facility 128 may compare datasets based on cost. The cost may be the cost of the service offering. The cost may be a monthly savings over an existing service. The cost may be an annual savings over an existing service. The ranking facility 128 may compare datasets based on cost plus another factor. The factors may be weighted by a user. The factors may be assigned a score. The score may be based on relevance to personal usage. The ranking facility 128 may compare datasets based on a calculated score. The score may be based on relevance to personal usage. The ranking facility 128 may compare datasets based on rewards associated with a credit card offering.

In an embodiment, the system may include a user-interface 102 for performing a comparison of services, receiving input from a user regarding a user's current service usage, wherein the service usage data may be analyzed to obtain a normalized usage dataset, and enabling the user to review a plurality of alternative service offering normalized datasets generated by application of a normalized alternative service offering model to a normalized service usage dataset. The input may be a usage history provided by a user manually. The input may be login information required to automatically acquire a billing record from a service provider or third-party billing agent.

In an embodiment, comparing service offerings may include a business rules server 122 for storing the definitions of a plurality of service usage-related data types, a data engine 120 for collecting service parameters related to a service usage using a computer implemented facility, a data normalization engine 124 for normalizing the service parameters according to the defined service usage-related data types to generate a normalized service usage model for alternative service offerings and a normalized service usage dataset for a user's current service, a decision engine 108 for applying a normalized service usage model to the normalized service usage dataset to produce a plurality of alternative service offering normalized datasets, and a ranking facility 128 for comparing the alternative service offering normalized datasets to the normalized usage dataset to determine if an alternative service offering is better than the user's current service. A monitoring engine 104 may cause the system 100 to periodically compare service offerings to determine on an updated basis which alternative service offering is better than the user's current service. The normalized service usage model may be stored in a product database 110. The normalized service usage dataset may be stored in a user profile database 112. The results from comparing may be stored in a tracking database 114.

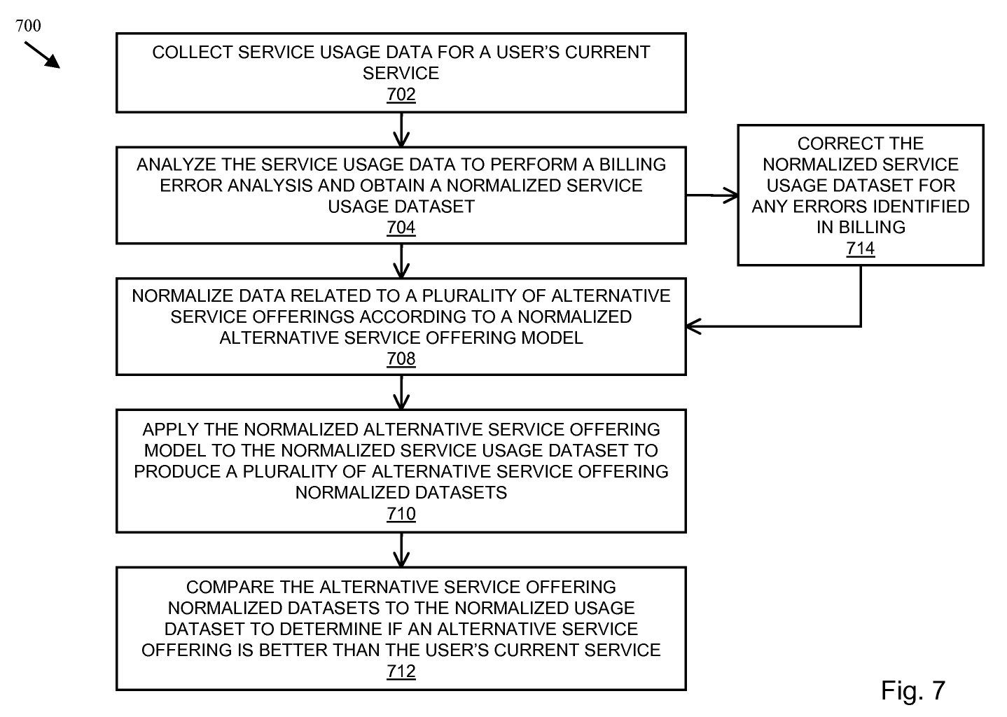

In an embodiment, referring to FIG. 7, the system 100 may collect service usage data for a user's current service using a computer implemented facility 702, analyze the service usage data to perform a billing error analysis and obtain a normalized service usage dataset 704, wherein the normalized service usage dataset may be optionally corrected for any errors identified in billing 714, normalize data related to a plurality of alternative service offerings according to a normalized alternative service offering model 708, apply the normalized alternative service offering model to the normalized service usage dataset to produce a plurality of alternative service offering normalized datasets 710, and compare the alternative service offering normalized datasets to the normalized usage dataset to determine if an alternative service offering is better than the user's current service 712. A service provider may be notified of an error in billing if an error is identified in analyzing the service usage data.

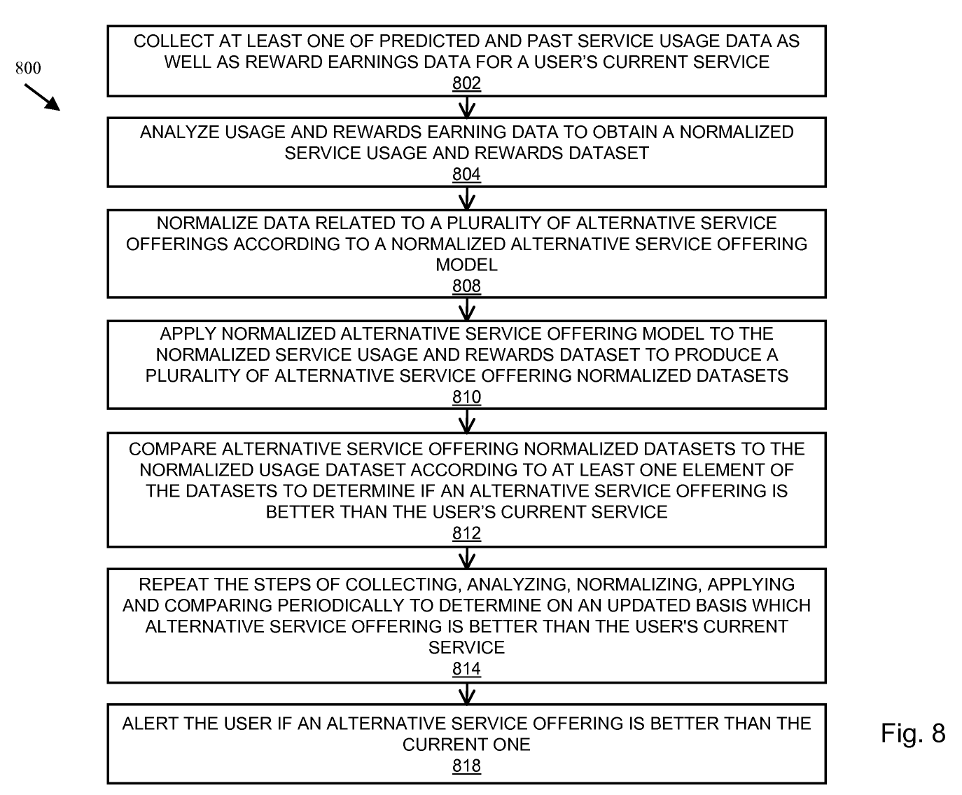

Referring to FIG. 8, the system 100 may provide a system, method, and medium of determining a personalized true cost of service offerings. A personalized cost of a service offering may be calculated for an individual based on your past and/or predicted usage data. The true cost, or impact, of ownership, such as the net cost including rewards and the like, may be quantifiable and unique to each offering. The system 100 may repeat the quantification periodically to alert users of a changed cost/impact when a new offer becomes available or when usage data changes. The system 100 may collect at least one of predicted and past service usage data as well as reward earnings data for a user's current service 802. The usage and rewards earning data may be analyzed to obtain a normalized service usage and rewards dataset 804. Optionally, data related to a plurality of alternative service offerings may be normalized according to a normalized alternative service offering model 808. Alternatively, the data normalized according to a normalized alternative service offering model may be purchased from a third party data provider. The normalized alternative service offering model may be applied to the normalized service usage and rewards dataset to produce a plurality of alternative service offering normalized datasets 810. Finally, the alternative service offering normalized datasets may be compared to the normalized usage dataset according to at least one element of the datasets to determine if an alternative service offering is better than the user's current service 812. The system 100 may repeat the steps of collecting, analyzing, normalizing, applying and comparing periodically to determine on an updated basis which alternative service offering is better than the user's current service 814. Additionally, if the system 100 determines that an alternative service offering is better than the current one, the user may be alerted 818.

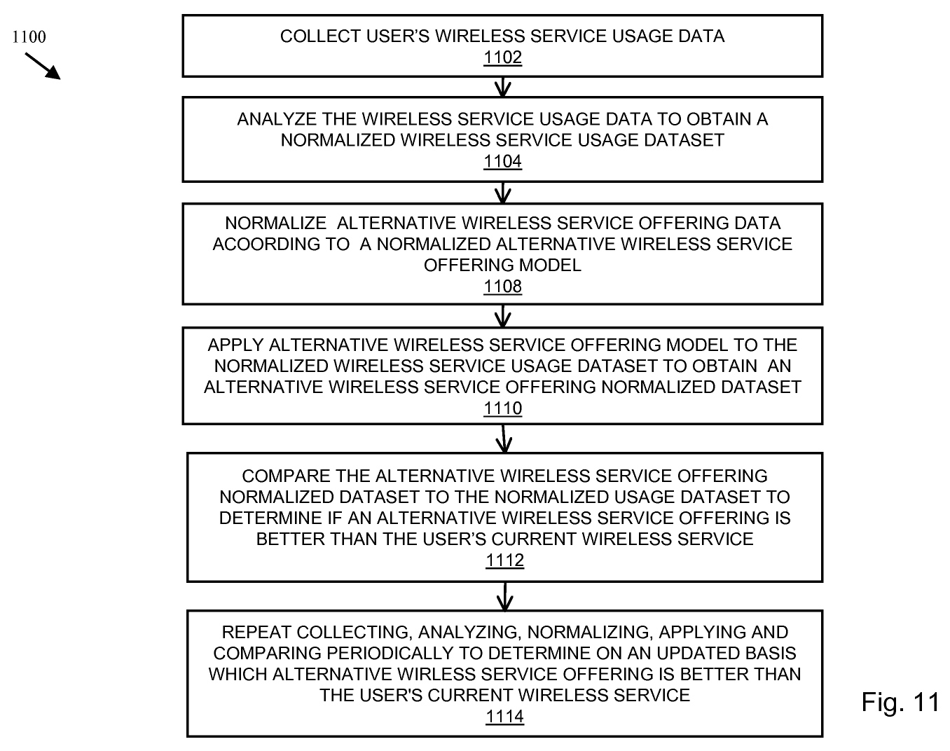

Referring now to FIG. 11, a method of comparing wireless service plans based on a user's wireless service usage data may include the steps of collecting wireless service usage data for a user's current wireless service using a computer implemented facility 1102, analyzing the wireless service usage data to obtain a normalized wireless service usage dataset 1104, optionally, normalizing data related to a plurality of alternative wireless service offerings according to a normalized alternative wireless service offering model 1108, applying the normalized alternative wireless service offering model to the normalized wireless service usage dataset to produce a plurality of alternative wireless service offering normalized datasets, wherein the dataset comprises at least the cost for the alternative service offering 1110, comparing the alternative wireless service offering normalized datasets to the normalized usage dataset to determine if an alternative wireless service offering is better than the user's current wireless service 1112, and optionally, repeating said collecting, analyzing, normalizing, applying and comparing periodically to determine on an updated basis which alternative wireless service offering is better than the user's current wireless service 1114.

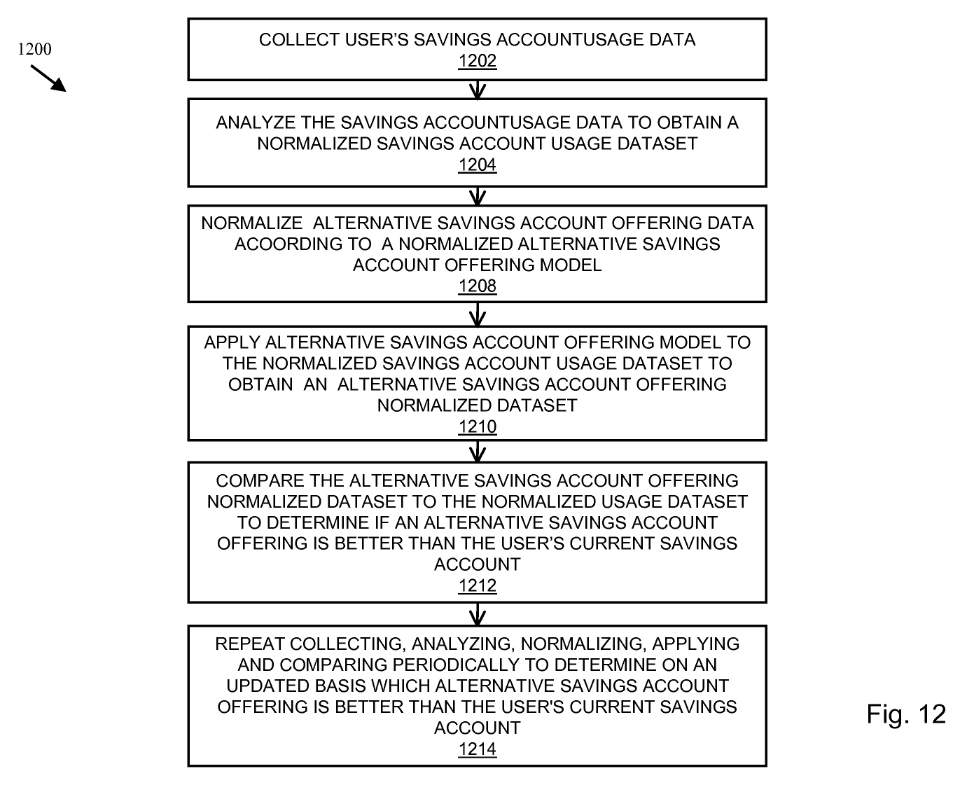

Referring now to FIG. 12, a method of comparing savings account offerings based on a user's savings account usage data may include the steps of collecting savings account usage data for a user's current savings account using a computer implemented facility 1202, analyzing the savings account usage data to obtain a normalized savings account usage dataset 1204, optionally, normalizing data related to a plurality of alternative savings account offerings according to a normalized alternative savings account offering model 1208, applying the normalized alternative savings account offering model to the normalized savings account usage dataset to produce a plurality of alternative savings account offering normalized datasets, wherein the dataset comprises at least the cost for the alternative savings account offering 1210, comparing the alternative savings account offering normalized datasets to the normalized usage dataset to determine if an alternative savings account offering is better than the user's current savings account 1212, and optionally, repeating said collecting, analyzing, normalizing, applying and comparing periodically to determine on an updated basis which alternative savings account offering is better than the user's current savings account 1214.

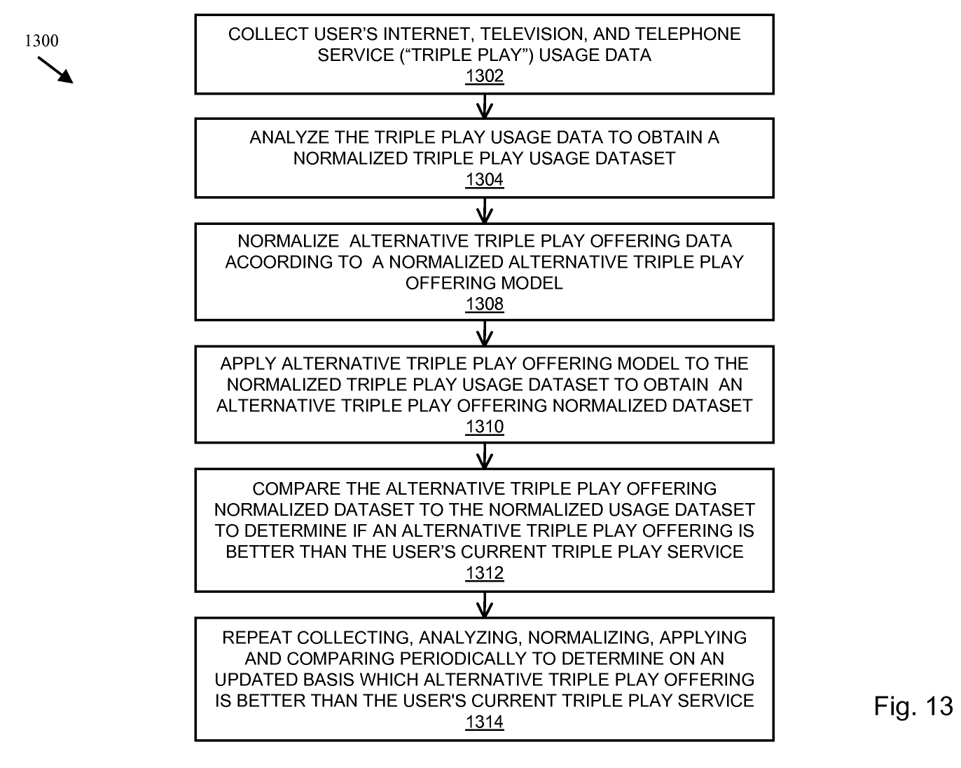

Referring now to FIG. 13, a method of comparing internet, television, and telephone (“triple play”) service plans based on a user's triple play service usage data may include the steps of collecting service usage data for a user's current triple play service using a computer implemented facility 1302, analyzing the triple play service usage data to obtain a normalized triple play service usage dataset 1304, optionally, normalizing data related to a plurality of alternative triple play service offerings according to a normalized alternative triple play service offering model 1308, applying the normalized alternative triple play service offering model to the normalized triple play service usage dataset to produce a plurality of alternative triple play service offering normalized datasets, wherein the dataset comprises at least the cost for the alternative triple play service offering 1310, comparing the alternative triple play service offering normalized datasets to the normalized usage dataset to determine if an alternative triple play service offering is better than the user's current triple play service 1312, and optionally, repeating said collecting, analyzing, normalizing, applying and comparing periodically to determine on an updated basis which alternative triple play service offering is better than the user's current triple play service 1314.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A machine readable medium, the machine readable medium having program instructions stored thereon for comparing service plans based on a user's usage data executable by a processing unit, the program instructions comprising the steps of:
collecting at least one of predicted and past service usage and reward earnings data for a user's current service using a computer implemented facility;
analyzing the service usage and rewards earnings data to obtain a normalized service usage and rewards dataset;
normalizing data related to a plurality of alternative service offerings according to a normalized alternative service offering model;
applying the normalized alternative service offering model to the normalized service usage and rewards dataset to produce a plurality of alternative service offering normalized datasets; and
comparing the alternative service offering normalized datasets to the normalized usage dataset according to at least one element of the datasets to determine if an alternative service offering is better than the user's current service.

2. The medium of claim 1, further comprising repeating said collecting, analyzing, normalizing, applying and comparing periodically to determine on an updated basis which alternative service offering is better than the user's current service.

3. The medium of claim 2, further comprising, alerting the user when an alternative service offering that is better than the user's current service is available.

4. The medium of claim 1, further comprising, calculating an aggregate score for each of the plurality of alternative service offering normalized datasets.

5. The medium of claim 4, wherein the aggregate score comprises cost and at least one other element.

6. The medium of claim 4, wherein the other element is selected from the group consisting of total cost, per unit cost, savings, and service quality.

7. The medium of claim 4, wherein the user specifies which aspects of the alternative service offering normalized dataset to include in the aggregate score.

8. The medium of claim 4, further comprising, ranking the plurality of alternative service offering normalized datasets based on the aggregate score.

9. The medium of claim 4, further comprising, collecting terms and conditions for the user's current service, analyzing the terms and conditions, calculating an aggregate score for the terms and conditions, and adding the aggregate score to the aggregate score for the normalized usage dataset.

10. The medium of claim 4, further comprising, collecting terms and conditions for the alternative service offerings, analyzing the terms and conditions, calculating an aggregate score for the terms and conditions, and adding the aggregate score to the aggregate score for the alternative service offering normalized dataset.

11. The medium of claim 1, wherein the data related to a plurality of alternative service offerings are obtained from a human-assisted normalization system.

12. The medium of claim 1, wherein the data related to a plurality of alternative service offerings are obtained from public information sources.

13. The medium of claim 1, wherein the data related to a plurality of alternative service offerings are obtained through direct connections to service providers.

14. The medium of claim 1, wherein the service usage data are input manually by the user to the computer implemented facility.

15. The medium of claim 1, wherein normalizing data related to the plurality of alternative service offerings, comprises:
defining a plurality of service usage-related data types;
collecting parameters related to a service usage using the computer implemented facility; and
normalizing the service parameters according to the defined service usage-related data types to generate a normalized alternative service offering model.

16. The medium of claim 1, wherein when the service offering is a wireless service offering, the service usage data and data related to the alternative service offering relate to at least one wireless service related item.

17. The medium of claim 1, wherein when the service offering is a credit card offering, the service usage data and data related to the alternative service offering relate to at least one credit card related item.

18. The medium of claim 1, wherein comparing comprises ranking the alternative service offerings according to an aggregate score calculated for the alternative service offering normalized dataset.

19. The medium of claim 1, wherein comparing comprises ranking the alternative service offerings according to cost and an aspect of the alternative service offering normalized dataset.

20. The medium of claim 1, wherein comparing comprises ranking the alternative service offerings according to total costs, per unit costs, and/or service quality.
